(19) United States
(12) Patent Application Publication
(10) Pub. No.: US 2006/0252906 A1
(43) Pub. Date: Nov. 9, 2006

(54) Method of synthesis of polyarylenes and the polyarylenes made by such method

(76) Inventors: James P. Godschalx, Midland, MI (US); James T. Pechacek, Indianapolis, IN (US); Kim E. Arndt, Carmel, IN (US)

Correspondence Address: THE DOW CHEMICAL COMPANY, INTELLECTUAL PROPERTY SECTION,, P. O. BOX 1967, MIDLAND, MI, 48641-1967, US

(21) Appl. No.: 10/545,861

(22) PCT Filed: Feb. 19, 2004
(86) PCT No.: PCT/US04/04986

§ 371 Date: May 26, 2006

Related U.S. Application Data
(60) Provisional application No. 60/449,568, filed on Feb. 20, 2003.

(51) Int. Cl. C08G 61/02

(52) U.S. Cl. 528/86

(57) ABSTRACT

The present invention is a method of making cross-linked or cross-linkable polyarylenes comprising providing a reaction mixture comprising (a) a first monomer comprising at least two cyclic functional groups (b) a second monomer comprising at least two dienophile functional groups, and heating the reaction mixture to form a polymerized or partially polymerized polyarylene material, wherein at least one of the first or second monomers must comprise at least three functional groups. The cyclic groups in the first monomer are characterized by the presence of two conjugated carbon to carbon double bonds and a leaving group, L, selected from -0-, —S—, —(SO₂)—, —N═N—, or —O(CO)—. The present invention is also the partially polymerized reaction product of the above method. Finally, the present invention is also specific difunctional diene monomers useful in such a method.

This invention relates to a method of synthesizing polyarylenes that are useful as dielectric materials in manufacture of microelectronic devices.

U.S. Pat. No. 5,965,679 taught new polyarylene materials made by the reaction of multifunctional monomers having cyclopentadienone and acetylene functional groups wherein at least one of the monomers had three functional groups. This patent taught that the polymers were formed by Diels Alder reaction of the cyclopentadienone groups with the acetylene groups. Thus, in the course of the reaction a new benzene ring is formed in the backbone of the polymer. Cross-linking and branching then occurred by subsequent reaction of the unreacted groups—acetylene-acetylene reactions being most likely while cyclopentadienone-acetylene and cyclopentadienone-cyclopentadienone reactions were also possible depending on the initial selection of monomers.

Other classes of materials have also been taught to undergo Diels Alder reaction. See e.g. Braham et. al. Macromolecules 11, 343 (1978); Liu et. al. J. Org. Chem. 61, 6693-99 (1996); van Kerckhoven et. al. Macromolecules 5, 541 (1972); Schilling et. al. Macromolecules 2, 85 (1969); Puetter et. al. J. Prakt. Chem. 149, 183 (1951); Feldman et. al. Tetrahedron Lett. 47, 7101 (1992); McDonald et. al. J. Chem. Soc. Perkin Trans. 1 1893 (1979); Turchi et. al. Tetrahedron 1809 (1998); Nakayama et. al. Tetrahedron Letters 35(17), 2709-2712 (1994), and Wong et. al. Heterocycles 20(9) 1815-39 (1983).

Nonetheless, it has remained unclear whether such classes would be suitable for use in preparation of polyarylene materials—particularly polyarylene materials intended for use in the electronics industry as interlayer dielectric materials.

Thus, the present invention is a new method of making cross-linked or cross-linkable polyarylenes comprising providing a reaction mixture comprising (a) a first monomer comprising at least two cyclic functional groups (b) a second monomer comprising at least two dienophile functional groups, and heating the reaction mixture to form a polymerized or partially polymerized polyarylene material, wherein at least one of the first or second monomers must comprise at least three functional groups. The cyclic groups in the first monomer are characterized by the presence of two conjugated carbon to carbon double bonds and a leaving group, L, selected from —O—, —S—, —(SO₂)—, —N═N—, or —O(CO)—. Thus, when the first monomer reacts with the second monomer in the presence of heat or other energy sources, L is removed to form an aromatic ring structure in the backbone of the oligomeric or polymeric structure being formed.

The present invention is also the partially polymerized reaction product of the above method. Phrased alternatively, the invention is an oligomeric or polymeric polyarylene material comprising residual cyclic groups characterized by the presence of two conjugated carbon to carbon double bonds and a leaving group, L, selected from —O—, —S—, —(SO₂)—, —N═N—, or —O(CO)—.

Finally, the present invention is also specific difunctional diene monomers useful in such a method.

The first monomers useful in the present invention are monomers which are characterized by the presence of two conjugated carbon to carbon double bonds and a leaving group, L, selected from —O—, —S—, —(SO₂)—, —N═N—, or —O(CO)—. Thus, when the first monomer reacts with the second monomer in the presence of heat or other energy sources, L is removed to form an aromatic ring structure in the backbone of the oligomeric or polymeric structure being formed.

Preferably, the first monomers are of the formula: (DE)ₙ-X, where DE is selected from 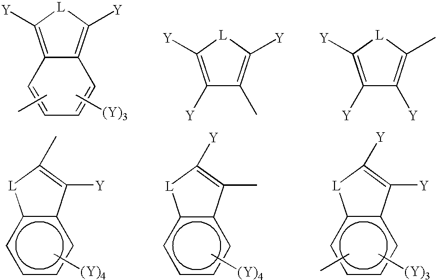
where L is selected from —O—, —S—, —(SO₂)—, —N═N—, or —O(CO)—, and is preferably —O— or —O(CO)—, Y is independently in each occurrence hydrogen, an aryl group of 6 to 10 carbon atoms, an alkyl group of 1-10 carbon atoms or two adjacent Y groups taken together with the carbon atoms to which they are attached form an aromatic ring of 6 carbon atoms.

n is an integer of 2 or more, preferably 2 or 3, more preferably 2.

X is a multivalent, preferably divalent, linking group or a single bond. Preferably X is O, or an organic divalent linking group. Examples of divalent organic linking groups include alkyl groups and more preferably, aromatic moieties such as: 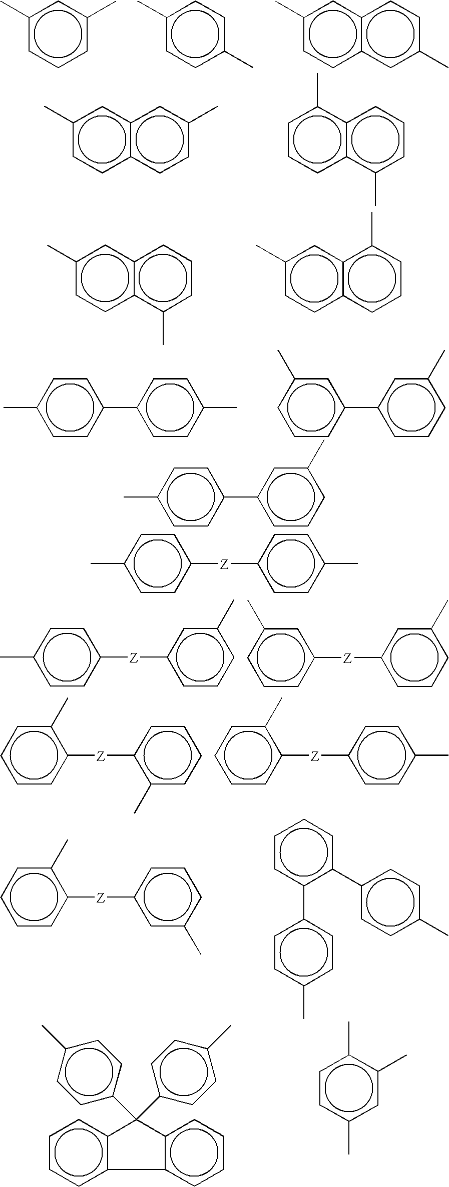 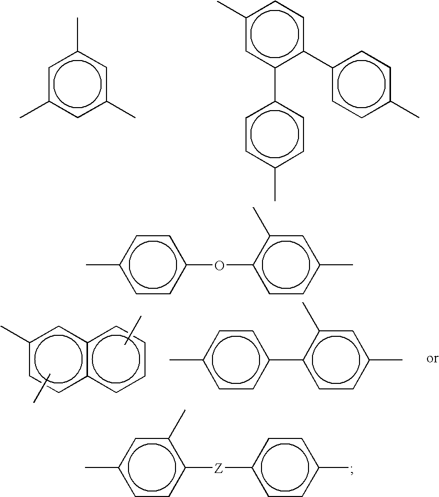
wherein Z can be: —O—, —S—, alkylene, —CF₂—, —CH₂—, —O—CF₂—, perfluoroalkyl, perfluoroalkoxy, 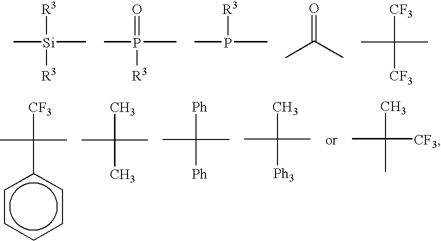
wherein each R³ is independently —H, —CH₃, —CH₂CH₃, —(CH₂)₂CH₃ or Ph. Ph is phenyl.

Such alkyl and aromatic groups may be unsubstituted or may be inertly substituted. An inert substituent is inert to the Diels Alder polymerization reactions and does not readily react under the conditions of use of the cured polymer in microelectronic devices with environmental species such as water.

The first monomer may be made by any suitable method determined by the skilled worker. Notably, attempts to make the pyrone containing monomers (i.e. where L is —O(CO)—) for example, where X is -biphenyl- or -phenyl-O-phenyl-, by (a) reacting coumalic acid with bisphenol or with dihydroxydiphenyloxide in the presence of a chemical dehydration agents (e.g. dicyclohexylcarbodiimide), (b) esterification of 4,4,-bisphenol with coumalic acid chloride using triethylamine as a base, (c) Friedel-Craft acylation of diphenyl ether with coumalic acid chloride in the presence of aluminum chloride, and (d) oxidation of a biscyclopentadienone diphenyl oxide failed to produce the desired product or produced an inseparable mixture from which the desired product could not be isolated. However, such materials can be made by Suzuki coupling of a halogenated pyrone with a boronic acid or boronate ester of diphenyl oxide in the presence of a palladium catalyst and a base. Alternatively, such materials may be made by Michael addition/Claisen condensation of a bisphenylacetyl phenylether with ethylphenyl propiolate. Similar methods should work for other species of bis-pyrones.

In fact, Applicants have made novel diphenylene ether bis pyrones of the structure as shown below: 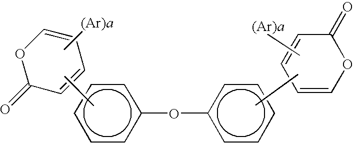
Where Ar is an aromatic ring, preferably a phenyl, and a is 0, 1 or 2.

Furan containing monomers (i.e. where L is —O—) may be made by any suitable method such as, for example

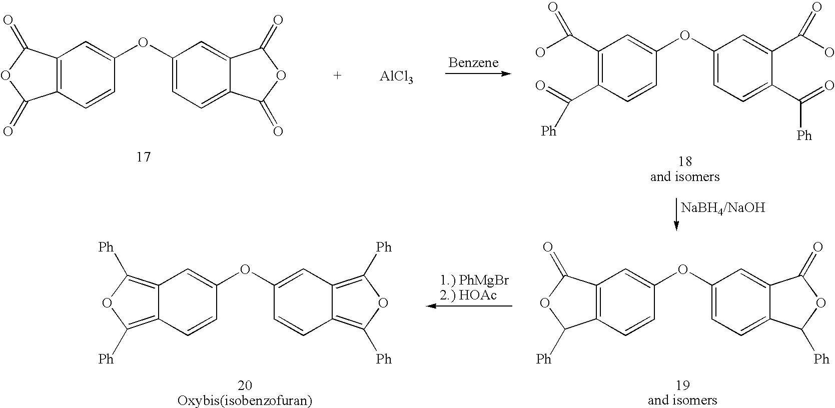

These first monomers are then reacted with a multifunctional monomer having at least two, preferably at least three dienophile groups or a mixture of multifunctional monomers, preferably at least some of which have at least three dienophile groups. Preferably, the dienophile is an acetylene group, more preferably a phenylacetylene. Thus, these second monomers have the formula:

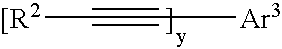

where R² is independently H or an unsubstituted or inertly-substituted aromatic moiety and Ar³ is independently an unsubstituted aromatic moiety or inertly-substituted aromatic moiety such as those described previously and y is 2 or more, preferably 3 or more.

The polymers or oligomers of this invention are formed by heating a reaction mixture comprising the two monomers. Preferably, the reaction occurs in a solvent.

Any inert organic solvent which can dissolve the monomers to the appropriate degree and can be heated to the appropriate polymerization temperature either at atmospheric, subatmospheric or superatmospheric pressure could be used. Examples of suitable solvents include pyridine, triethylamine, N-methylpyrrolidinone (NMP), methyl benzoate, ethyl benzoate, butyl benzoate, cyclopentanone, cyclohexanone, cycloheptanone, cyclooctanone, cyclohexylpyrrolidinone, and ethers or hydroxy ethers such as dibenzylethers, diglyme, triglyme, diethylene glycol ethyl ether, diethylene glycol methyl ether, dipropylene glycol methyl ether, dipropylene glycol dimethyl ether, propylene glycol phenyl ether, propylene glycol methyl ether, tripropylene glycol methyl ether, toluene, mesitylene, xylene, benzene, dipropylene glycol monomethyl ether acetate, dichlorobenzene, propylene carbonate, naphthalene, diphenyl ether, butyrolactone, dimethylacetamide, dimethylformamide and mixtures thereof. The preferred solvents are mesitylene, N-methylpyrrolidinone (NMP), gamma-butyrolactone, diphenylether and mixtures thereof.

Alternatively, the monomers can be reacted in one or more solvents at elevated temperature and the resulting solution of oligomers can be cooled and formulated with one or more additional solvents to aid in processing, for example. In another approach, the monomers can be reacted in one or more solvents at elevated temperature to form oligomers which can then be isolated by precipitation into a non-solvent or by some other means of solvent removal to give essentially solvent-free oligomers. These isolated oligomers can then be redissolved in one or more different solvents and the resultant solutions can be used for processing.

The conditions under which the polymerization reaction is most advantageously conducted are dependent on a variety of factors, including the specific reactants and solvent. In general, the reaction is conducted under a non-oxidizing atmosphere such as a blanket of nitrogen or other inert gases. The reaction can be conducted neat (without solvent or other diluents). However, in order to ensure homogeneous reaction mixtures and to moderate exothermic reactions at such temperatures, it is often desirable to use inert organic solvents, such as those mentioned previously, for the reactants.

The time and temperature most advantageously employed will vary depending on the specific monomers employed, particularly their reactivity, the specific oligomer or polymer desired, and the solvent. In general, the reaction to form the oligomers is conducted at a temperature of from about 150° C. to about 250° C. and for a time of from about 60 minutes to about 48 hours. At this point the oligomers may be isolated from the reaction mixture or used as is in the coating of a surface. Additional chain extension (advancement) may be conducted at a temperature of from about 100° C. to about 475° C., preferably from about 200° C. to about 450° C. and for a time of from about 1 minute to about 10 hours, more preferably from about 1 minute to about 1 hour. An uncured or partially cured polymer may be used for coating a surface by casting from a solvent. While such a polymer may not gap fill or planarize sufficiently, it may still be useful in a damascene process.

The concentrations at which the monomers are most advantageously employed in the organic liquid reaction medium are dependent on a variety of factors including the specific monomers and organic liquid employed and the oligomer and polymer being prepared. In general, the monomers are employed in a diene to dienophile stoichiometric ratio of from about 3:1 to about 1:3, preferably at a 1.5:1 to 1:2 ratio.

The oligomer or polymer can be directly cast as a film, applied as a coating or poured into a non-solvent to precipitate the oligomer or polymer. Water, methanol, ethanol and other similar polar liquids are typical non-solvents which can be used to precipitate the oligomer. Solid oligomer or polymer may be dissolved and processed from a suitable solvent. If the oligomer or polymer is obtained in solid form, it may be further processed using conventional compression molding techniques or melt spinning, casting or extrusion techniques provided the solid precursor has a sufficiently low glass transition temperature.

More commonly, the oligomer or polymer is processed directly from the organic liquid reaction solution and the advantages of the present invention are more fully realized in that instance. Since the oligomer or polymer is soluble in the organic liquid reaction medium, the organic solution of the oligomer can be cast or applied and the solvent evaporated. Molecular weight increases (chain extension or advancement), and in some examples, crosslinking, to form the final polymer, occurs upon subsequent exposure to a sufficiently high temperature.

The polymer of this invention may be used as one or more of the insulating or dielectric layers in single or multiple layer electrical interconnection architectures for integrated circuits, multichip modules, or flat panel displays. The polymer of the invention may be used as the sole dielectric in these applications or in conjunction with other organic polymers or inorganic dielectrics, such as silicon dioxide, silicon nitride, or silicon oxynitride.

For example, coatings of oligomers and polymers of the invention, such as an electrically insulating coating used to fabricate interconnect structures on an electronic wafer, are easily prepared by spin-casting a film of, or otherwise coating a substrate with, the organic liquid solution of the oligomer or polymer and then evaporating the solvent and exposing the oligomer or polymer to temperatures sufficient to advance the oligomer or polymer to higher molecular weight, and in the most preferred examples, to a crosslinked polymer with high glass transition temperature.

The polymers of the present invention are particularly useful as a low dielectric constant insulating material in the interconnect structure of an integrated circuit, such as those fabricated with silicon or gallium arsenide. An integrated circuit would typically have multiple layers of metal conductors separated by one or more insulating materials. The polymer material of this invention can be used as insulation between discrete metal conductors in the same layer, and/or between conductor levels of the interconnect structure. The polymers of the present invention can also be used in combination with other materials, such as SiO₂ or Si₃N₄, in a composite interconnect structure. For example, the oligomers and polymers of the invention may be used in the process for making integrated circuit devices taught in U.S. Pat. No. 5,550,405; U.S. Pat. No. 5,591,677 and Hayashi et al., 1996 Symposium on VLSI Technology Digest of Technical Papers, pg 88-89, all of which are incorporated herein by reference. The oligomers and polymers of the invention may be substituted for the BCB or other resin disclosed in the process disclosed.

The oligomer, uncured polymer or polymer of the invention may be used as a dielectric in the above taught processes or similar processes to fabricate an integrated circuit article comprising an active substrate containing transistors and an electrical interconnect structure containing patterned metal lines separated, at least partially, by layers or regions of the composition of the invention.

The polymers of the present invention are also useful to planarize materials such as silicon wafers used in semiconductors to allow the production of smaller (higher density) circuitry. To achieve the desired planarity, a coating of the oligomer or polymer is applied from solution such as by spin coating or spray coating, to flow so as to level any roughness on the surface of the substrate. These methods are illustrated by such references as Jenekhe, S. A., Polymer Processing to Thin Films for Microelectronic Applications in Polymers for High-Technology, Bowden et al. ed., American Chemical Society 1987, pp. 261-269.

In the fabrication of microelectronic devices, relatively thin defect-free films, generally from 0.01 to 20, preferably from 0.1 to 2 micrometer thickness, can be deposited on a surface of a substrate for example silicon, silicon-containing materials, silicon dioxide, alumina, copper, silicon nitride, aluminum nitride, aluminum, quartz, and gallium arsenide. The dissolved oligomer or polymer can be cast onto a substrate by common spin and spray coating techniques. The thickness of the coating may be controlled by varying the percent solids, the molecular weight, and thus the viscosity of the solution as well as by varying the spin speed.

The polyarylene oligomer or polymer in this invention may be applied either by dip coating, spray coating, extrusion coating, or more preferably by spin coating.

Adhesion promoters, such as those based on silane chemistry, may be applied to the substrate prior to the application of the polyarylene oligomer or polymer solution, or added directly to the solution.

The oligomers and polymers of the present invention can be used in either a “damascene” metal inlay or subtractive metal patterning scheme for fabrication of integrated circuit interconnect structure. Processes for fabricating damascene lines and vias are known in the art. See for example U.S. Pat. Nos. 5,262,354 and 5,093,279.

Patterning of the material may be done with typical reactive ion etch procedures using oxygen, argon, nitrogen, helium, carbon dioxide, fluorine containing compounds, or mixtures of these and other gases, using a photoresist “softmask” , such as an epoxy novolac, or a photoresist in combination with an inorganic “hardmask” such as SiO₂, Si₃N₄, or metal.

The oligomers and polymers may be used in conjunction with Al, Al alloys, Cu, Cu alloys, gold, silver, W, and other common metal conductor materials (for conductive lines and plugs) deposited by physical vapor deposition, chemical vapor deposition, evaporation, electroplating, electroless deposition, and other deposition methods. Additional metal layers to the basic metal conductors, such as tantalum, titanium, tungsten, chromium, cobalt, their alloys, or their nitrides, may be used to fill holes, enhance metal fill, enhance adhesion, provide a barrier, or modify metal reflectivity.

Depending on the fabrication architecture, either metal or the dielectric material of this invention may be removed or planarized using chemical-mechanical polishing techniques.

Multichip modules on active or passive substrates such as silicon, silicate glass, silicon carbide, aluminum, aluminum nitride, or FR-4, may be constructed with the polyarylene polymer of this invention as a dielectric material.

Flat panel displays on active or passive substrates such as silicon, silicate glass, silicon carbide, aluminum, aluminum nitride, or FR-4, may be constructed with the polyarylene polymer of this invention as a dielectric material.

The oligomers and polymers of the present invention may further be used as protective coatings on integrated circuit chips for protection against alpha particles. Semiconductor devices are susceptible to soft errors when alpha particles emitted from radioactive trace contaminants in the packaging or other nearby materials strike the active surface. An integrated circuit can be provided with a protective coating of the polymer of the present invention. Typically, an integrated circuit chip would be mounted on a substrate and held in place with an appropriate adhesive. A coating of the polymer of the present invention provides an alpha particle protection layer for the active surface of the chip. Optionally, additional protection is provided by encapsulant made of, for example, epoxy or a silicone.

The polymers of the present invention may also be used as a substrate (dielectric material) in circuit boards or printed wiring boards. The circuit board made up of the polymer of the present invention has mounted on its surface patterns for various electrical conductor circuits. The circuit board may include, in addition to the polymer of the present invention, various reinforcements, such as woven nonconducting fibers, such as glass cloth. Such circuit boards may be single sided, as well as double sided or multilayer.

The polymers of the present invention may also be useful in reinforced composites in which a resin matrix polymer is reinforced with one or more reinforcing materials such as a reinforcing fiber or mat. Representative reinforcing materials include fiber glass, particularly fiber glass mats (woven or non-woven); graphite, particularly graphite mat (woven or non-woven); Kevlar™; Nomex™; and glass spheres. The composites can be made from preforms, dipping mats in monomer or oligomer, and resin transfer molding (where the mat is placed into the mold and monomer or prepolymer is added and heated to polymerize).

Layer(s) of the polymers of the present invention may be patterned by such means as wet-etching, plasma-etching, reactive-ion etching (RIB), dry-etching, or photo laser ablation, such as illustrated by Polymers for Electronic Applications, Lai, CRC Press (1989) pp. 42-47. Patterning may be accomplished by multilevel techniques in which the pattern is lithographically defined in a resist layer coated on the polymeric dielectric layer and then etched into the bottom layer. A particularly useful technique involves masking the portions of oligomer or polymer not to be removed, removing the unmasked portions of oligomer or polymer, then curing the remaining oligomer or polymer, for example, thermally.

In addition, the oligomer of the present invention may also be employed to make shaped articles, films, fibers, foams, and the like. In general, techniques well-known in the art for casting oligomers or polymers from solution may be employed in the preparation of such products.

In preparing shaped polyarylene oligomer or polymer articles, additives such as fillers, pigments, carbon black, conductive metal particles, abrasives and lubricating polymers may be employed. The method of incorporating the additives is not critical and they can conveniently be added to the oligomer or polymer solution prior to preparing the shaped article. The liquid compositions containing the oligomer or polymer, alone or also containing fillers, may be applied by any of the usual techniques (doctoring, rolling, dipping, brushing, spraying, spin coating, extrusion coating or meniscus coating) to a number of different substrates. If the polyarylene oligomer or polymer is prepared in solid form, the additives can be added to the melt prior to processing into a shaped article.

The oligomer and polymer of the present invention can be applied to various substrates by a number of methods such as, solution deposition, liquid-phase epitaxy, screen printing, melt-spinning, dip coating, roll coating, spinning, brushing (for example as a varnish), spray coating, powder coating, plasma-deposition, dispersion-spraying, solution-casting, slurry-spraying, dry-powder-spraying, fluidized bed techniques, welding, explosion methods including the Wire Explosion Spraying Method and explosion bonding, press bonding with heat, plasma polymerization, dispersion in a dispersion media with subsequent removal of dispersion media, pressure bonding, heat bonding with pressure, gaseous environment vulcanization, extruding molten polymer, hot-gas welding, baking, coating, and sintering. Mono- and multilayer films can also be deposited onto a substrate using a Langmuir-Blodgett technique at an air-water or other interface.

When applying the oligomer or polymer of the invention from solution, specific conditions of polymerization and other processing parameters most advantageously employed are dependent on a variety of factors, particularly the specific oligomer or polymer being deposited, the conditions of coating, the coating quality and thickness, and the end-use application, with the solvent being selected accordingly. Representative solvents which can be employed are those described previously.

Substrate(s) which can be coated with the oligomer or polymer of the invention can be any material which has sufficient integrity to be coated with the monomer, oligomer or polymer. Representative examples of substrates include wood, metal, ceramics, glass, other polymers, paper, paper board cloth, woven fibers, non-woven fiber mats, synthetic fibers, Kevlar™, carbon fibers, gallium arsenide, silicon and other inorganic substrates and their oxides. The substrates which are employed are selected based on the desired application. Exemplary materials include glass fibers (woven, non-woven or strands), ceramics, metals such as aluminum, magnesium, titanium, copper, chromium, gold, silver, tungsten, stainless steel, Hastalloy™, carbon steel, other metal alloys and their oxides, and thermoset and thermoplastic polymers such as epoxy resins, polyimides, perfluorocyclobutane polymers, benzocyclobutane polymers, polystyrene, polyamides, polycarbonates, polyarylene ethers and polyesters. The substrate can be the polymers of the present invention in cured form.

The substrate may be of any shape, and the shape is dependent on the end-use application. For instance, the substrate may be in the form of a disk, plate, wire, tubes, board, sphere, rod, pipe, cylinder, brick, fiber, woven or non-woven fabric, yarn (including commingled yarns), ordered polymers, and woven or non-woven mat. In each case the substrate may be hollow or solid. In the case of hollow objects, the polymer layer(s) is on either or both the inside or outside of the substrate. The substrate may comprise a porous layer, such as graphite mat or fabric, glass mat or fabric, a scrim, and particulate material.

The oligomers or polymers of the invention adhere directly to many materials such as compatible polymers, polymers having a common solvent, metals, particularly textured metals, silicon or silicon dioxide, especially etched silicon or silicon oxides, glass, silicon nitride, aluminum nitride, alumina, gallium arsenide, quartz, and ceramics. However, when increased adhesion is desired, a material may be introduced to improve adhesion.

Representative examples of such adhesion promoting materials are silanes, preferably organosilanes such as trimethoxyvinylsilane, triethoxyvinylsilane, hexamethyldisilazane [(CH₃)₃—Si—NH—Si(CH₃)₃], or an aminosilane coupler such as γ-aminopropyltriethoxysilane, or a chelate such as aluminum monoethylacetoacetatediisopropylate [((isoC₃H₇O)₂Al(OCOC₂H₅CHCOCH₃))]. In some cases, the adhesion promoter is applied from 0.01 weight percent to 5 weight percent solution, excess solution is removed, and then the polyarylene applied. In other cases, for example, a chelate of aluminum monoethylacetoacetatedi-isopropylate, can be incorporated onto a substrate by spreading a toluene solution of the chelate on a substrate and then baking the coated substrate at 350° C. for 30 minutes in oxygen to form a very thin (for example 5 nanometer) adhesion promoting layer of aluminum oxide on the surface. Other means for depositing aluminum oxide are likewise suitable. Alternatively, the adhesion promoter, in an amount of, for example, from 0.05 weight percent to 5 weight percent based on the weight of the monomer, can be blended with the monomer before polymerization, negating the need for formation of an additional layer.

Adhesion can also be enhanced by surface preparation such as texturizing (for example, scratching, etching, plasma treating, or buffing) or cleaning (for example, degreasing or sonic cleaning); otherwise treating (for example, plasma, solvent, SO₃, plasma glow discharge, corona discharge, sodium, wet etching, or ozone treatments) or sand blasting the substrate's surface or using electron beam techniques such as 6 MeV fluorine ions; electrons at intensities of 50 to 2000V; hydrogen cations at 0.2 to 500 ev to 1 MeV; helium cations at 200 KeV to 1 MeV; fluorine or chlorine ions at 0.5 MeV; neon at 280 KeV; oxygen enriched flame treatment; or an accelerated argon ion treatment.

The oligomer or polymer of the invention can be applied in combination with other additives to obtain specific results. Representative of such additives are metal-containing compounds such as magnetic particles, for example, barium ferrite, iron oxide, optionally in a mixture with cobalt, or other metal containing particles for use in magnetic media, optical media, or other recording media; conductive particles such as metal or carbon for use as conductive sealants, conductive adhesives, conductive coatings, electromagnetic interference (EMI)/radio frequency interference (RFI) shielding coating, static dissipation, and electrical contacts. When using these additives, the oligomer or polymer of the invention may act as a binder.

The oligomer or polymer of the invention may also be employed as protection against the environment (that is, protective against at least one substance or force in an object's environment, including conditions of manufacture, storage and use) such as coatings to impart surface passivation to metals, semiconductors, capacitors, inductors, conductors, solar cells, glass and glass fibers, quartz and quartz fibers.

The oligomers or polymers of this invention may be combined with porogen materials. As used herein porogen materials are materials which form small domains within a matrix which comprises the oligomers or polymers of this invention. The porogen is then removed after the matrix is cured to form a porous structure. The porogen may be removed by solvent extraction or by degradation followed by diffusion through the matrix. Thermal methods of removing the porogen by heating are preferred.

The porogens are preferably nanoparticles having an average diameter less than 30, more preferably less than 20, and most preferably less than 15 nm. The nanoparticles may be any particle that based on its chemical structure maintains its shape whether in the presence of a solvent or not. By maintains its shape is meant that the particle does not unwind or elongate upon interaction with the solvents or matrix materials but rather forms domains within that matrix material of a size similar to that of the initial nanoparticle. It may swell with matrix materials or solvents as they penetrate into the nanoparticle, but the nanoparticle will nevertheless retain its shape. Examples of such nanoparticles include, star polymers, dendrimers and hyperbranched polymers (e.g. polyamidoamine (PAMAM), dendrimers as described by Tomalia, et al., Polymer J (Tokyo), Vol. 17, 117 (1985), which teachings are incorporated herein by reference; polypropylenimnine polyamine (DAB-Am) dendrimers available from DSM Corporation; Frechet type polyethereal dendrimers (described by Frechet, et al., J. Am. Chem. Soc., Vol. 112, 7638 (1990), Vol. 113, 4252(1991)); Percec type liquid crystal monodendrons, dendronized polymers and their self-assembled macromolecules (described by Percec, et al., Nature, Vol. 391, 161(1998), J. Am. Chem. Soc., Vol. 119, 1539(1997)); hyperbranched polymer systems such as Boltorn H series dendritic polyesters (commercially available from Perstorp AB). More preferably the nanoparticles should be crosslinked polymeric nanoparticles. The particles preferably have a shape approximating a Newtonian object (e.g. a sphere) although misshapen (e.g. slightly oblong or elliptical, bumpy, etc.) particles may be used as well. For polyarylene and polyarylene ether matrix materials, styrene based nanoparticles are preferred. However, the nanoparticle may comprise other monomers such as 4-tert-butylstyrene, divinylbenzene, 1,3-diisopropenylbenzene, methyl acrylate, butyl acrylate, hydroxypropyl acrylate, 4-hydroxybutyl acrylate, and the like.

The nanoparticles should be selected such that they thermally decompose, preferably in the absence of air, at a temperature above suitable polymerization temperatures for the matrix material but below the glass transition temperature for the cured matrix materials. Particularly, it is critical that the matrix material has sufficiently set up or cured prior to decomposition of the nanoparticle so as to avoid pore collapse.

These nanoparticles may comprise reactive functionality or reactive functional groups. By reactive functionality or reactive functional groups is meant a chemical species which is characterized in that it reacts with the matrix precursor during the partial polymerization of the monomeric precursors. Examples of such reactive functionality include ethylenic unsaturated groups, hydroxyl, acetylene, amine, phenylethynyl, cyclopentadienone, α,β-unsaturated esters, α,β-unsaturated ketones, maleimides, aromatic and aliphatic nitriles, coumalic esters, 2-furanoic esters, propargyl ethers and esters, propynoic esters and ketones, etc. that are available to react the nanoparticles with the matrix materials during the partial polymerization of the monomers. The functional groups may be residual groups that remain after synthesis or manufacture of the particle or may be added by subsequent additional reaction steps.

The most preferred nanoparticles are crosslinked polystyrene, acrylate or methacrylate based nanoparticles. The preferred nanoparticles may be made by emulsion polymerization of styrene monomers (e.g. styrene, alpha methyl styrene, etc.) with a comonomer having at least two ethylenically unsaturated groups capable of free radical polymerization (e.g. divinylbenzene and 1,3-diisopropenylbenzene).

Since it is anticipated that the compositions will be used in microelectronics manufacture it is desirable that the composition contain little or no ionic impurities.

The following examples are set forth to illustrate the present invention and should not be construed to limit its scope. In the examples, all parts and percentages are by weight unless otherwise indicated.

### EXAMPLES

Synthesis of Monomers

### (A) Unsubstituted pyrone monomer 5,5′-(Oxydi-4,1-phenylene)bis-2H-pyran-2-one (8)

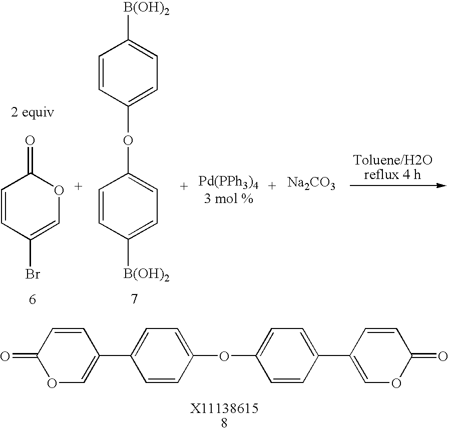

To a slurry of 4,4′-oxybisphenyl boronic acid (1.87 g, 7.25 mmol) in toluene (675 mL) was added 5-bromo-2H-pyran-2-one (5.0 g, 29 mmol), and 31.5 mL of a 2 M solution of aqueous Na₂CO₃ (6.7 g, 63.6 mmol). The mixture was sparged with N₂ for 0.5 h, and then tetrakis(triphenylphosphine)palladium(0) (1.04 g, 0.9 mmol) was added. The mixture was refluxed for 4 h, cooled, filtered to remove solids, and then washed with brine. The organic layer was dried (MgSO₄) and concentrated under reduced pressure. Purification of the residue by silica gel chromatography (0-50% v/v EtOAc/Hexanes) gave the title compound (0.75 g, 30%) as an orange solid; mp 210-214° C. dec. ¹H NMR (CDCl₃): δ 7.69 (dd, 2H), 7.63 (dd, 2H), 7.38 (d, 4H), 7.11 (d, 4H), 6.46 (dd, 2H). HRMS Q-TOF m/z: calcd for C₂₂H₁₄O₅ ([M+NH₄]⁺) 358.0841, found 358.0833.

(B) Substituted pyrone monomer 6,6′-(Oxydi-4,1-phenylene)bis[4,5-diphenyl]-2H-pyran-2-one (11)

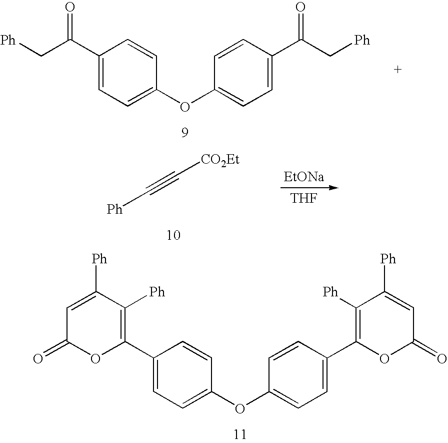

To a slurry of 4,4′-bis(phenylacetyl)phenyl ether (5.0 g, 12.3 mmol), and ethyl phenylpropiolate (5.3 g, 31 mmol), in dry ether (225 mL) was added dry sodium ethoxide (1.6 g, 23 mmol). The reaction had made no progress after 16 hr at room temperature, so dry THF (200 mL) was added. The yellowish red reaction slurry was stirred at room temperature for an additional 30 h at room temperature. The reaction mixture was poured into 1 L of ethyl acetate and washed with dilute aqueous HCl. The organic layer was dried over MgSO₄, filtered and concentrated to a tan solid. This solid was dissolved in CH₂Cl₂ and purified by column chromatography using a 30% acetone/70% hexane as the mobile phase on a Waters Prep 500 fitted with two compression columns in series. The product fractions were collected and condensed. The residue was dried under vacuum at 50° C. overnight to give the title compound (1.8 g, 22%) as tan solid; mp 264-266° C. ¹H NMR (CDCl₃, 300 MHz) δ 7.1-7.3 (m, 16H); 7.0 (d, 4H); 6.9 (dd, 4H); 6.8 (d, 4H); 6.38 (s, 2H). ¹³C NMR (CDCl₃, 300 MHz) 163.8; 161.6; 159.1; 157.5; 157.2; 136.8; 134.2; 131.2; 128.5; 128.4; 128.2; 127.9; 127.5; 118.2; 113.1. Anal. Calc'd for C₄₆H₃₀O₅: C, 83.37; H, 4.56. Found: C, 83.97; H, 4.36.

### Oxybis(isobenzofuran)

The above monomer may be made by the following process: The anhydride 17 is converted to the mixed keto acid 18 through Friedel-Crafts acylation of benzene. Sodium borohydride reduction of 18 with base promoted ring closure gives the mixed lactone 19. Carbonyl attack with phenylmagnesium bromide followed by dehydration in hot glacial acetic acid provides the product (20). 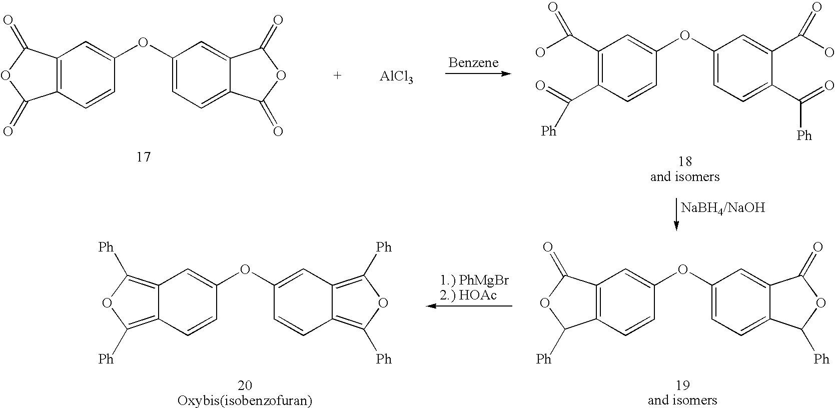
Evaluation of Formation of Cross-Linked or Cross-Linkable Polymers or Oligomers

The method of this invention to form crosslinkable or cross-linked polyarylenes was evaluated by combining and reacting the monomers as follows: An equimolar mixture of bis-diene as listed in Table 1 and 1,3,5-tris(phenylethynyl)benzene (“Tris”) was weighed into a Schlenk tube and diluted with lo gamma-butyrolactone such that the total percent solids was either 30% or 15% depending on the solubility of the monomers. The slurry of monomers was degassed using a series of vacuum/nitrogen cycles. The tube was held under a static nitrogen pressure and then immersed in an oil bath which was then heated to 200° C. Samples were withdrawn periodically and analyzed by GPC. The reaction mixture was also visibly analyzed for the presence of gels. Control reactions of each monomer reacted alone in gamma-butyrolactone at 200° C. were also run and analyzed for comparison. Gel permeation chromatography (GPC) was performed on an Agilent 1100 series HPLC system using tetrahydrofuran as eluting solvent at 1 mL/min. using two Polymer Labs PL-gel Mixed C columns in series with a diode array UV-vis detector set to 254 nm. Calibration curves were created using Polymer Labs Easi-cal polystyrene calibration standards. All molecular weights reported are relative to polystyrene.

The results are shown in Table 1.

TABLE 1

| | % | B-stage | | | |
|---|---|---|---|---|---|
| Monomer | Solids | Time | | Mn | Mw |
| Unsubstituted | 30 | 3 | h | 794 | 2500 |
| Pyrone (8) + Tris | | | | | |
| | | 6.25 | h | 968 | 4564 |
| | | 8 | h | gelled | |
| Unsubstituted Pyrone (8) | 30 | 0 | h | 390 | 435 |
| | | 5 | h | 516 | 1418 |
| | | 8 | h | 646 | 2369 |
| | | 24 | h | 461 + gels | 11880 + gels |
| Substituted | 30 | 23.5 | h | 608 | 804 |
| Pyrone (11) + Tris | | | | | |
| | | 72 | h | 994 | 1606 |
| | | 190 | h | 2249 | 6095 |
| Substituted Pyrone (11) | 30 | 0 | h | 534 | 545 |
| | | 5 | h | 529 | 580 |
| | | 8 | h | 530 | 568 |
| | | 24 | h | 547 | 591 |
| | | 48 | h | 532 | 588 |
| Oxy | 15 | 4 | h | 1008 | 2262 |
| Bis-isobenzofuran + Tris | | | | | |
| | | 6.75 | h | 999 | 2349 |
| | | 23.5 | | 1222 | 3358 |
| Bis-isobenzofuran | 15 | 0 | h | 339 | 386 |
| | | 3 | h | 332 | 353 |
| | | 6.5 | h | 367 | 390 |
| | | 72 | h | 412 | 476 |
| 2,2′-Dithiophene + Tris | 30 | 21 | h | 116 | 310 |
| | | 117 | h | 160 | 619 |
| 3,3′-Dithiophene + Tris | 30 | 21 | h | | |
| | | 117 | h | 107 | 278 |

The thiophenes were obtained from Aldrich.

What is claimed is:

1. A method for making cross-linked or cross-linkable polyarylenes comprising
providing a reaction mixture comprising (a) a first monomer comprising at least two cyclic functional groups (b) a second monomer comprising at least two dienophile functional groups, and
heating the reaction mixture to form a polymerized or partially polymerized polyarylene material, wherein at least one of the first or second monomers must comprise at least three functional groups and wherein the cyclic groups in the first monomer are characterized by the presence of two conjugated carbon to carbon double bonds and a leaving group, L, selected from —O—, —S—, —(SO₂)—, —N═N—, or —O(CO)—.

2. The method of claim 1 wherein first monomers are of the formula: (DE)ₙ-X, where DE is selected from 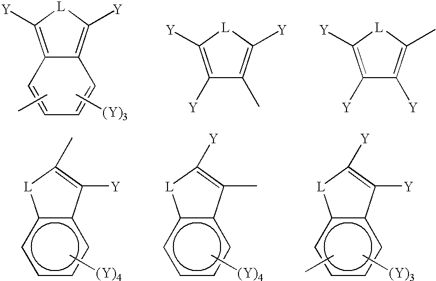
where L is selected from —O—, —S—, —(SO₂)—, —N═N—, or —O(CO)—, and is preferably —O— or —O(CO)—, Y is independently in each occurrence hydrogen, an aryl group of 6 to 10 carbon atoms, an alkyl group of 1-10 carbon atoms or two adjacent Y groups taken together with the carbon atoms to which they are attached form an aromatic ring of 6 carbon atoms;
n is an integer of 2 or more; and
X is a multivalent linking group or a single bond.

3. The method of claim 1 wherein L is —O— or —O(CO)—.

4. The method of claim 2 wherein the second monomer has the formula: 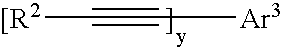
where R² is independently H or an unsubstituted or inertly-substituted aromatic moiety and Ar³ is independently an unsubstituted aromatic moiety or inertly-substituted aromatic moiety such as those described previously and y is 3 or more.

5. The method of claim 1 wherein the monomers are dispersed in a solvent.

6. The method of claim 1 wherein the first monomer has the formula: 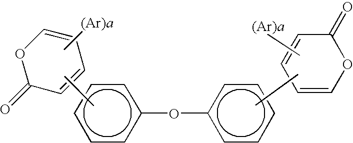
where Ar is an aromatic group and a is 0, 1 or 2.

7. A curable polymer made by the method of claim 1 wherein polymerization is stopped before gellation occurs.

8. A composition comprising the polymer of claim 7.

9. The composition of claim 8 further comprising a porogen.

10. A film comprising the polymer of claim 7 wherein the polymer has been cured by subsequent heating.

11. An article comprising the film of claim 10.

12. A monomer having the formula: 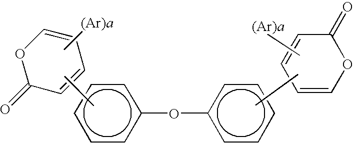
where Ar is an aromatic group and a is 0, 1 or 2.
